(19) United States
(12) Patent Application Publication
(10) Pub. No.: US 2024/0002988 A1
(43) Pub. Date: Jan. 4, 2024

(54) IN-SITU STRENGTHENING AND RAPID FORMING METHOD FOR THIN-WALLED TITANIUM ALLOY TUBULAR COMPONENT

(71) Applicant: Harbin Institute of Technology, Harbin City (CN)

(72) Inventors: Kehuan WANG, Harbin City (CN); Gang LIU, Harbin City (CN)

(21) Appl. No.: 18/048,523

(22) Filed: Oct. 21, 2022

(30) Foreign Application Priority Data
Jul. 4, 2022 (CN) 202210782025.6

(51) Int. Cl. C22F 1/18

(52) U.S. Cl. CPC C22F 1/183

(57) ABSTRACT

An in-situ strengthening and rapid forming method for thin-walled titanium alloy tubular components. The method includes the following steps: the tube blank is placed in a forming die which is at a room temperature, and after the two ends of the tube blank are sealed, the tube blank is heated within 1 min. The heating for the tube blank is stopped after the temperature of the tube blank reaches a predetermined temperature, and a high-pressure gas is immediately introduced into the tube blank. So, the tube blank is bulged rapidly to the inner wall of the forming die. After the pressure in the tube blank reaches a predetermined pressure, the predetermined pressure is maintained for 3-10 s and the tube blank is cooled in the forming die. Then, the high-pressure gas is discharged to obtain the thin-walled titanium alloy tubular component.

### CROSS REFERENCE TO RELATED APPLICATIONS

This patent application claims the benefit and priority of Chinese Patent Application No. 202210782025.6, filed on Jul. 4, 2022, the disclosure of which is incorporated by reference herein in its entirety as part of the present application.

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE DISCLOSURE

### Technical Field of the Disclosure

The present disclosure relates to the technical field of strengthening a thin-walled titanium alloy tubular component, and in particular, to an in-situ strengthening and rapid forming method for a thin-walled titanium alloy tubular component.

### Description of the Related Art

With the development of the aircraft aiming at high speed, quick response, high thrust force and high reliability, the requirements on the performance of the thin-walled integral components made of titanium alloys are getting higher and higher. However, in a conventional hot forming process of the thin-walled titanium alloy component, the forming process is heated for a s long time heating, which may cause the performance of the formed component thereof to decrease. If the heat treatment is performed after the component is formed, the secondary deformation of the component may occur.

Furthermore, when utilizing existing forming technology, the thin-walled tube made of the titanium alloy may require simultaneously heating of a forming die and the tube. When the size of the forming die is larger, the heating time is longer, and the forming efficiency is lower. Further, when a dedicated heat-resistant forming die needs to be used, this forming die is easy to wear, and the service life of this forming die is relatively short at the elevated temperatures, which may be required. As a result, the production cost of the component is relatively high, and the requirements for high launching frequency and high reliability of an aircraft in fields such as aeronautics and aerospace cannot be satisfied. Therefore, there is an urgent need to develop a forming process for the thin-walled titanium alloy tubular component which is capable of strengthening the performance of the tube during the forming process with a high efficiency, so as to realize the synchronous control of the dimensional accuracy and the post-formed performance of the tube.

### SUMMARY

In at least one aspect, the problem solved by the present disclosure is to provide a method for improving the forming efficiency of a thin-walled titanium alloy tubular component and improving the performance of the formed thin-walled tube.

In order to solve at least one aspect of the above-described problems, some embodiments provide an in-situ strengthening and rapid forming method for a thin-walled titanium alloy tubular component, including the following steps:
Step S1, placing a titanium alloy tube blank in a forming die which is at a room temperature (20 to 22 degrees Celsius); and sealing the tube blank in the forming die by sealing punches after the forming die is closed;
Step S2, heating the tube blank rapidly, and controlling a heating time for the tube blank to be within 1 min;
Step S3, stopping the heating of the tube blank when a temperature of the tube blank reaches a predetermined temperature, and immediately introducing a high-pressure gas into the tube blank, rapidly bulging the tube blank to the inner wall of the forming die; and after a pressure in the tube blank reaches a predetermined pressure, maintaining the predetermined pressure in the tube blank and cooling the tube blank, so as to obtain a formed tube, where a pressurization time for the pressure in the tube blank to the predetermined pressure is controlled within 2 seconds (s), and a dwell time for maintaining the predetermined pressure in the tube blank is 3-10 s;
Step S4, discharging the high-pressure gas in the formed tube after the formed tube is cooled, so as to obtain the thin-walled titanium alloy component.

In a potentially preferred embodiment of the disclosure, in the step S3, bulging the tube blank to the inner wall of the forming die may comprise: introducing the high-pressure gas into the tube blank via the sealing punches, such that the tube blank bulges, and is closely attached to the inner wall of the cavity of the forming die, where the tube blank is in a high-temperature state, and the forming die is in a room temperature; cooling the tube blank after being bulged rapidly by the forming die to obtain the formed tube, where lots of fine martensites (very hard forms of steel crystalline structures) are formed inside the formed tube.

In another potentially preferred embodiment of the disclosure, in the step S3, the predetermined temperature is within a range of 50 degrees Celsius around the beta phase transus temperature of the titanium alloy tube blank.

In yet another potentially preferred embodiment of the disclosure, the step S2 may comprise: controlling a heating rate for the tube blank at 10-200° C./s; and when the predetermined temperature is greater than or equal to the beta phase transus temperature of the titanium alloy tube blank, controlling the heating rate at 50-200 degree ° C./s.

In yet another potentially preferred embodiment of the disclosure, the step S3 may comprise: introducing the high-pressure gas into the tube blank, such that the pressure in the tube blank reaches 5-35 MPa.

In yet another potentially preferred embodiment of the disclosure, when the predetermined temperature is less than a beta phase transus temperature of the titanium alloy tube blank, the pressure in the tube blank to reach 10-35 MPa may be enabled; when the predetermined temperature is greater than or equal to the beta phase transus temperature of the titanium alloy tube blank, the pressure in the tube blank may reach 5-15 MPa.

In yet another potentially preferred embodiment of the disclosure, control of a pressurization rate for the pressure in the tube blank to the predetermined pressure to be above 10 MPa/s may be required to achieve the results as described herein.

In yet another potentially preferred embodiment of the disclosure, step S2 may comprise: heating the tube blank in an electric current heating manner.

In yet another potentially preferred embodiment of the disclosure, the titanium alloy tube blank may comprise one or more of TA18, TA15, TC2, TC4, TC31, Ti55, Ti60 and Ti65.

In select embodiments of the disclosure, a tube blank made of the titanium alloy may be rapidly heated to the predetermined temperature, the forming die may be maintained at a room temperature, and the heating time of the tube blank may be controlled within 1 min, which can avoid the serious growth of the beta phases of the tube blank caused by long-term heating of the tube blank. In this way, deterioration of the plasticity and tensile strength of the material of the tube blank caused by long-term heating could also be avoided. Furthermore, much less heat may be required due to the separate heating of the tube blank made of the titanium alloy. When the high-pressure gas (i.e. compressed gas) is introduced into the forming die to bulge the tube blank made of the titanium alloy, the tube blank with the high temperature can be in contact with the room temperature forming die. The pressurization time for the tube blank can be controlled within 2 s, and the dwell time for the tube blank is 3-10 s. Under the action of both the high-pressure gas and the forming die, the temperature of the bulged tube blank can be rapidly reduced to achieve the purpose of in-die quenching. Due to the shorter time of the tube blank made of the titanium alloy under the high temperature condition, a large number of fine martensitic microstructures are formed in the formed tube, thereby increasing the strength of the formed tube. That is to say, in the present embodiments, by means of rapid heating and rapid cooling of the tube blank, the time of the tube blank made of the titanium alloy under the high temperature condition in a forming process may be significantly reduced, the problem of the growth of beta phases of the tube blank under the high temperature condition in the forming process can be avoided, a large amount of fine martensitic microstructures can be obtained in the formed tube, the performance of the formed tube may be improved, and the requirements of an aircraft can be met. In addition, the in-situ strengthening and rapid forming method for a thin-walled titanium alloy tubular component provided by the present embodiments may only require the heating of the tube blank made of the titanium alloy without heating the forming die, which can significantly reduce the energy consumption required for heating, and improve the forming efficiency of the thin-walled tube made of the titanium alloy. So, the in-situ strengthening performance of the formed tube and the dimensional accuracy of the formed tube may effectively occur.

### BRIEF DESCRIPTION OF THE DRAWINGS

FIG. 1 is a flowchart of an in-situ strengthening and rapid forming method for a thin-walled titanium alloy tubular component according to an embodiment of the present disclosure;

FIG. 2 is a schematic flowchart of an in-situ strengthening and rapid forming method for the thin-walled titanium alloy tubular component according to an embodiment of the present disclosure;

FIG. 3 is a curve diagram of a process of an in-situ strengthening and rapid forming method for the thin-walled titanium alloy tubular component according to an embodiment of the present disclosure;

FIG. 4 is a variation diagram of the microstructure of a titanium alloy at different heating rates according to an embodiment of the present disclosure;

FIG. 5A is a comparison diagram of mechanical properties of a TC4 titanium alloy at different heating rates according to an embodiment of the present disclosure;

FIG. 5B is a diagram of microstructure of a TC4 titanium alloy according to an embodiment of the present disclosure;

FIG. 5C is another diagram of microstructure of a TC4 titanium alloy according to an embodiment of the present disclosure;

FIG. 5D is yet another diagram of microstructure of a TC4 titanium alloy according to an embodiment of the present disclosure;

FIG. 6 is a comparison diagram of mechanical properties of both the thin-walled Ti60 titanium alloy tubular component and an original Ti60 titanium alloy material at 600° C. according to a fifth embodiment of the present disclosure;

FIG. 7 is a microstructure of the original Ti60 titanium alloy material; and

FIG. 8 is a microstructure of the thin-walled Ti60 titanium alloy tube according to the fifth embodiment of the present disclosure.

### DETAILED DESCRIPTION OF THE EMBODIMENTS

To make the above objectives, features, and advantages of the present disclosure more clearly and comprehensibly, specific embodiments of the present disclosure are described in detail below.

It should be noted that the features in the embodiments of the present disclosure may be combined with each other without conflicts. The meaning of the terms “comprising”, “including”, “containing”, “having” is intended to be non-limiting, i.e., other steps and other components may be added which do not affect the result. The above terms encompass the terms “consisting of” and “essentially consisting of”. Material, equipment, reagents are all commercially available as if not specifically stated.

In the prior art, it is generally considered that when the titanium alloy is subjected to a heat treatment at a temperature near a beta phase transus temperature of the titanium alloy, a serious growth of the beta phases is caused, thereby resulting in a large size of the alpha-cluster in the treated titanium alloy, which reduces the plasticity and the tensile strength of the material of the titanium alloy. Accordingly, during the processing of the thin-walled component made of the titanium alloy, the processing at the temperature near the beta phase transus temperature is generally avoided.

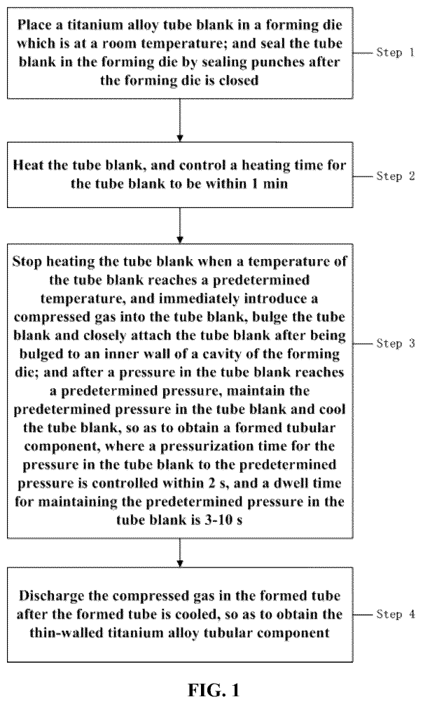

An embodiment of the present disclosure may provide an in-situ strengthening and rapid forming method for a thin-walled titanium alloy tubular component. As shown in FIG. 1, an exemplary method of the disclosure may include the following steps S1 to S4, as described below.

In step S1, a tube blank made of the titanium alloy is placed in a forming die which may be allowed to proceed at a room temperature, and after the forming die is closed, the tube blank made of the titanium alloy in the forming die can be sealed via sealing punches.

In step S2, the tube blank made of the titanium alloy can be heated rapidly, and a heating time of the tube blank can be controlled within 1 min.

In step S3, when a temperature of the tube blank made of the titanium alloy reaches a predetermined temperature, the heating of the tube blank can be stopped, and a high-pressure gas is immediately introduced into the tube blank made of the titanium alloy, such that the tube blank made of the titanium alloy rapidly bulges and can be closely attached to an inner wall of a cavity of the forming die, so as to obtain a formed tube. The pressurization time for the tube blank can be controlled within 2 s, and a 3-10 s dwell time for the tube blank can be achieved.

In step S4, after the formed tube may be cooled, and the high-pressure gas in the formed tube may be discharged, so as to obtain the thin-walled tube made of the titanium alloy.

In step S1, the brand name of the tube blank made of the titanium alloy includes one or more of TA18, TA15, TC2, TC4, TC31, Ti55, Ti60 and Ti65. The microstructure in the original tube blank made of the titanium alloy may be an equiaxed microstructure. The tube blank made of the titanium alloy may be placed in the forming die, and the tube blank made of the titanium alloy may be sealed in the forming die via the sealing punches, such that a closed space can be formed inside the forming die. The size of the cavity of the forming die may be greater than the size of the tube blank made of the titanium alloy. Each of two ends of the tube blank made of the titanium alloy may be connected to a corresponding one of electrodes on the forming die.

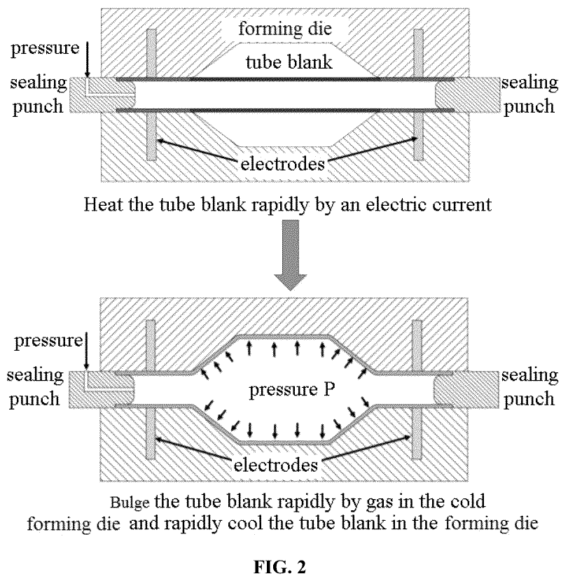

In an exemplary embodiment, as shown in FIG. 2, the forming die includes an upper forming die and a lower forming die. The upper forming die and the lower forming die can be configured to form the cavity with narrower ends and larger middle portion when the upper forming die and the lower forming die are closed. The forming die may be opened, the tube blank made of the titanium alloy can be put into the forming die, then the forming die can be closed, and thus two ends of the tube blank made of the titanium alloy can be sealed via the sealing punches, so as to seal the tube blank made of the titanium alloy in the forming die.

In step S2, the tube blank made of the titanium alloy may be heated by a current via electrodes connected to the tube blank, so as to increase the temperature thereof. In order to avoid the serious growth of the beta phases in the tube blank caused by an excessively long heating time, the heating time of the tube blank can be controlled within 1 min. At the same time, the mold may not be heated, so as to keep the temperature of the mold at a lower temperature.

In this exemplary embodiment, as shown in FIG. 2, after the forming die is closed, only small areas at the two ends of the tube blank made of the titanium alloy may be in contact with the forming die, while most of areas of the tube blank may not be in contact with the forming die. When the tube blank is directly heated, the temperature of the forming die may not be significantly increased, so that the forming die can be kept at a relatively low temperature condition.

In step S3, when the temperature of the tube blank made of the titanium alloy reaches the predetermined temperature, the heating of the tube blank can be immediately stopped, and the high-pressure gas is introduced into the tube blank via the sealing punches, thereby bulging the heated tube blank until the tube blank closely attaches to the inner wall of the cavity of the forming die. In this case, the temperature of the tube blank may remain or be caused to become relatively high, while the temperatures of the high-pressure gas and the inner wall of the cavity of the forming die may remain or be caused to become relatively low. So, the temperature of the bulged tube blank may rapidly decrease under the action of both the high-pressure gas and the inner wall of the cavity of the forming die, thereby completing the rapid cooling process in the forming die to obtain a formed tube. The predetermined temperature may be within a range of 50° C. around the beta phase transus temperature of the tube blank made of the titanium alloy. By setting the predetermined temperature within this range, a large amount of non-coarsened non-equilibrium beta phases can be formed in the heated tube blank. When the temperature is too low, sufficient non-equilibrium beta phases cannot be formed. When the temperature is too high, excessive growth of the beta phases is easily caused, and the performance of the formed thin-walled tube can be affected.

It should be understood by those having ordinary skill in the art that, since different tube blanks made of the titanium alloy have different beta phase transus temperatures, the predetermined temperatures for heating the tube blanks are also different. Suitable heating rates can be set, such that the heating time of the tube blanks is maintained within 1 min. In potentially preferred embodiments of the disclosure, the heating rates should all be maintained at 10-200° C./s. When the predetermined temperature is greater than or equal to the beta phase transus temperature of the tube blank made of the titanium alloy, the heating rate may be 50-200° C./s.

Specifically, a high-pressure gas can be introduced into the forming die through the sealing punches, the high-pressure gas enters the interior of the heated tube blank made of the titanium alloy, and the pressure in the forming die can be controlled to reach 5-35 MPa. When the predetermined temperature is less than the beta phase transus temperature of the tube blank made of the titanium alloy, the pressure in the forming die can be controlled to reach 10-35 MPa. When the predetermined temperature is greater than or equal to the beta phase transus temperature of the tube blank made of the titanium alloy, the pressure in the forming die (i.e., the tube blank) can be controlled to reach 5-15 MPa. Since the tube blank made of the titanium alloy subjected to the rapid heat treatment may have a preferable plasticity, the high-pressure gas inside the cavity of the tube blank can gradually increase, so that the pressure inside the tube blank increases. The tube blank may then bulge under the effect of the pressure, until it may be closely attached to the inner wall of the cavity of the forming die, so the expansion of the tube blank can be stopped. The total pressurization time for the tube blank can be controlled within 2 s, and the dwell time for the tube blank may be 3-10 s. When the bulged tube blank is closely attached to the inner wall of the cavity of the forming die, the inner wall of the cavity of the forming die at a lower temperature may cool the bulged tube blank rapidly, so as to obtain the formed tube.

It should be understood by those having ordinary skill in the art that, according to different material properties of the tube blank made of the titanium alloy, the pressure in the forming die after the pressurization can be controlled within a range of 5-35 MPa. Specifically, when the predetermined temperature is less than the beta phase transus temperature of the tube blank made of the titanium alloy, the pressure inside the forming die can be optimally controlled to reach 10-35 MPa. When the predetermined temperature is greater than or equal to the beta phase transus temperature of the tube blank made of the titanium alloy, the pressure inside the forming die can be controlled to reach 5-15 MPa. Furthermore, if the total pressurization time for the tube blank can be controlled within 2 s, the dwell time for the tube blank may be 3-10 s, and the pressurization rate for the tube blank can be kept above 10 MPa/s.

When the pressure is set to be 5-35 MPa, the tube blank made of the titanium alloy can be bulged and closely attached to the inner wall of the cavity of the forming die, and the tube blank will not be damaged due to an excessive pressure. The pressurization rate for the tube blank may be controlled to be not less than 10 MPa/s, the total pressurization time for the tube blank may be controlled to be within 2 s, and the dwell time for the tube blank can be controlled to be 3-10 s. Accordingly, following such a procedure may avoid temperatures of the heated tube blank decreasing, the plasticity thereof decreasing, and the tube blank breaking during the expansion process thereof, due to an excessively long forming time for the tube blank.

In this exemplary embodiment, as shown in FIG. 2, the sealing punches may occur in communication with an inner ring of the tube blank made of the titanium alloy, and the high-pressure gas being injected into the forming die (i.e., the tube blank) through the sealing punch. The high-pressure gas may enter the interior of the heated tube blank made of the titanium alloy. Since the heated tube blank may possess a preferable plasticity, when the high-pressure gas is injected continuously and the pressure in the tube blank increases continuously, the tube blank may bulge, until the tube blank is closely attached to the inner wall of the cavity of the forming die. Thus, the shaping of the tube blank can be completed, and a formed tube can be obtained.

In step S4, after the tube is formed, the high-pressure gas in the formed tube can be discharged. After the formed tube is cooled, a thin-walled tube made of the titanium alloy can be obtained.

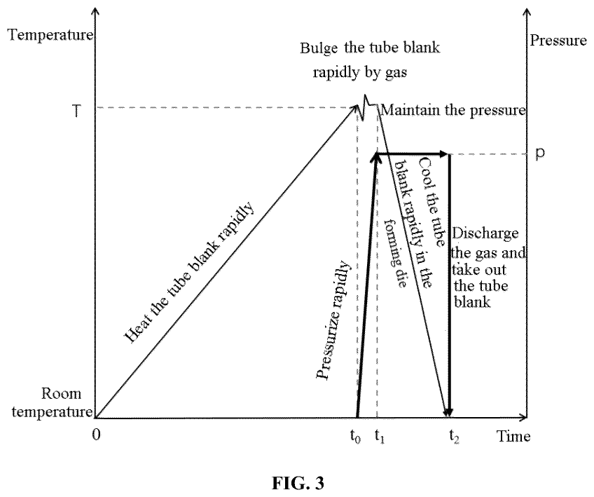

FIG. 3 is a process diagram of an in-situ strengthening and rapid forming method for the thin-walled tube made of a titanium alloy according to an embodiment of the present disclosure. In FIG. 3, the horizontal axis denotes time, the vertical axis on the left side denotes temperature, and the vertical axis on the right side denotes air pressure.

It can be seen from FIG. 3 that, after the tube blank made of the titanium alloy is rapidly heated, the tube blank can be rapidly raised to a temperature T, then the high-pressure gas can be immediately introduced into the tube blank to rapidly pressurize to a pressure P. So, the tube blank may then rapidly bulge. After maintaining the pressure inside the tube blank at the pressure P for a period of time, the tube blank can be quickly cooled down to a room temperature in the forming die, then the formed tube of the tube blank may be decompressed and taken out, so as to complete the in-situ strengthening and rapid forming method for the tube blank made of the titanium alloy. In FIG. 3, a time period of 0-t₁ may be a heating time for the tube blank, and the heating time can be controlled within 1 min; a time period of t₀-t₁ may be a pressurization time for the tube blank, and the pressurization time can be controlled within 2 s; a time period of t₁-t₂ may be a dwell time for the tube blank, and the dwell time may be 3-10 s.

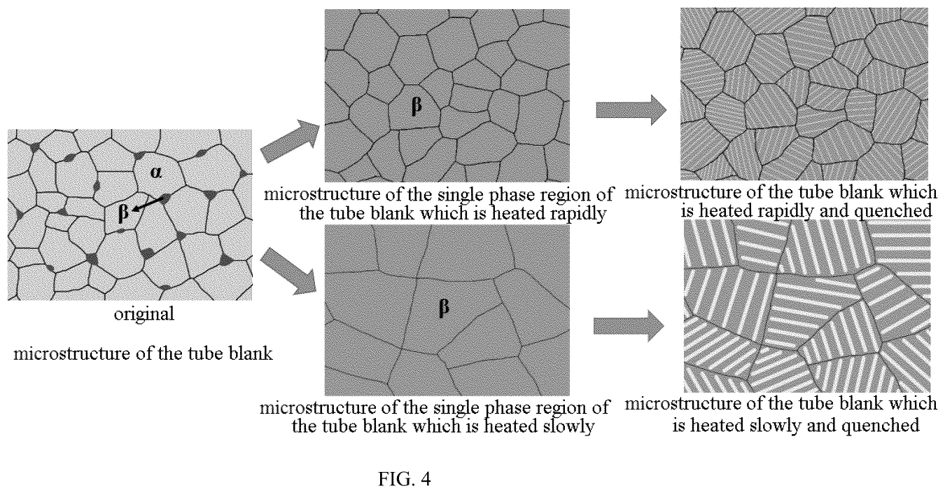

FIG. 4 is a variation diagram of the microstructure of the tube blank at different heating rates. When the tube blank is rapidly heated (i.e., the total heating time is less than or equal to 1 min), a large amount of non-coarsened non-equilibrium beta phases may be formed in the heated tube blank. A large amount of fine martensites may be formed after the tube blank is rapidly cooled. So, the strength of the formed tube can be improved. When the tube blank is slowly heated (i.e., the total heating time is greater than 1 min), the growth of the beta phases in the heated tube blank are serious, and larger martensites can be formed after the tube blank is rapidly cooled, thereby resulting in a lower strength of the formed tube. It should be noted that, in order to simplify the comparison of effects at different heating rates, FIG. 4 only shows the evolution of the microstructure of the beta-phases area in the tube blank during heating the tube blank. However, in the actual process, when the heating temperature of the tube blank is slightly lower than the beta phase transus temperature, the formed tube may also contain a small amount of primary alpha-phase microstructure.

The present disclosure will be further described in conjunction with the following specific embodiments. It should be understood by those having ordinary skill in the art that these embodiments are only intended to illustrate the present disclosure, but not to limit the scope of the present disclosure. In the following embodiments, the experimental methods without specific conditions generally follow the conditions recommended by the manufacturer.

### Example 1

The present embodiment provides an in-situ strengthening and rapid forming method for a thin-walled tube made of a titanium alloy, the exemplary method includes the following steps 1.1 to 1.4.

In step 1.1, a TC4 titanium alloy tube blank may be placed in a forming die, and the TC4 titanium alloy tube blank in the forming die may be sealed via sealing punches.

In step 1.2, the TC4 titanium alloy tube blank can be heated to 1000° C. (the beta phase transus temperature of the TC4 titanium alloy is 990° C.), the heating rate for the TC4 titanium alloy tube blank may be 50° C./s, the heating time for the TC4 titanium alloy tube blank may be 20 s, and the forming die can be maintained at a room temperature.

In step 1.3, when the temperature of the TC4 titanium alloy tube blank reaches 1000° C., the heating of the TC4 titanium alloy tube blank may be stopped, and the high-pressure gas can be immediately introduced into the TC4 titanium alloy tube blank via the sealing punches, such that the pressure in the forming die (i.e., the tube blank) reaches 12 MPa and can be maintained for 5 s. So, the TC4 titanium alloy tube blank bulges and can be closely attached to the cavity of the forming die. The pressure rate for the TC4 titanium alloy tube blank may be 15 MPa/s, and the pressurization time for the TC4 titanium alloy tube blank may be 0.8 s. When the bulged TC4 titanium alloy tube blank contacts the cavity of the forming die which is at a room temperature, the temperature of the TC4 titanium alloy tube blank can rapidly decrease, and the rapid cooling in the forming die can be completed, so as to obtain a formed tube.

In step 1.4, the high-pressure gas in the TC4 titanium alloy tube blank may be discharged, the formed tube can be cooled, and the forming die can be opened to obtain a thin-walled tube made of the titanium alloy.

### Example 2

The present embodiment provides an in-situ strengthening and rapid forming method for a thin-walled tube made of a titanium alloy, the method includes the following steps 2.1 to 2.4.

In step 2.1, a TC4 titanium alloy tube blank may be placed in a forming die, and the TC4 titanium alloy tube blank in the forming die may be sealed via sealing punches.

In step 2.2, the TC4 titanium alloy tube blank can be heated to 1000° C. (the beta phase transus temperature of the TC4 titanium alloy is 990° C.), the heating rate for the TC4 titanium alloy tube blank may be 100° C./s, the heating time for the TC4 titanium alloy tube blank may be 10 s, and the forming die can be maintained at a room temperature.

In step 2.3, when the temperature of the TC4 titanium alloy tube blank reaches 1000° C., the heating of the TC4 titanium alloy tube blank may be stopped, and the high-pressure gas can be immediately introduced into the TC4 titanium alloy tube blank via the sealing punches, such that the pressure in the forming die reaches 12 MPa and can be maintained for 5 s. So, the TC4 titanium alloy tube blank bulges and can be closely attached to the cavity of the forming die. The pressure rate for the TC4 titanium alloy tube blank may be 15 MPa/s, and the pressurization time for the TC4 titanium alloy tube blank may be 0.8 s. When the bulged TC4 titanium alloy tube blank contacts the cavity of the forming die which is at a room temperature, the temperature of the TC4 titanium alloy tube blank can rapidly decrease, and the rapid cooling in the forming die can be completed, so as to obtain a formed tube.

In step 2.4, the high-pressure gas in the TC4 titanium alloy tube blank may be discharged, the formed tube can be cooled, and the forming die can be opened to obtain a thin-walled tube made of the titanium alloy.

### Example 3

The present embodiment provides an in-situ strengthening and rapid forming method for a thin-walled tube made of a titanium alloy, the method includes the following steps 3.1 to 3.4.

In step 3.1. a TC4 titanium alloy tube blank may be placed in a forming die, and the TC4 titanium alloy tube blank in the forming die can be sealed via sealing punches.

In step 3.2. the TC4 titanium alloy tube blank can be heated to 1000° C. (the beta phase transus temperature of the TC4 titanium alloy is 990° C.), the heating rate for the TC4 titanium alloy tube blank may be 100° C./s, the heating time for the TC4 titanium alloy tube blank may be 10 s, and the forming die can be maintained at a room temperature.

In step 3.3. when the temperature of the TC4 titanium alloy tube blank reaches 1000° C., the heating of the TC4 titanium alloy tube blank can be stopped, and the high-pressure gas may be immediately introduced into the TC4 titanium alloy tube blank via the sealing punches, such that the pressure in the forming die reaches 5 MPa and may be maintained for 10 s. So, the TC4 titanium alloy tube blank bulges and can be closely attached to the cavity of the forming die. The pressure rate for the TC4 titanium alloy tube blank may be 10 MPa/s, and the pressurization time for the TC4 titanium alloy tube blank may be 0.5 s. When the bulged TC4 titanium alloy tube blank contacts the cavity of the forming die which is at a room temperature, the temperature of the TC4 titanium alloy tube blank rapidly decreases, and the rapid cooling in the forming die can be completed, so as to obtain a formed tube.

In step 3.4. the high-pressure gas in the TC4 titanium alloy tube blank may be discharged, the formed tube can be cooled, and the forming die can be opened to obtain a thin-walled tube made of the titanium alloy.

### Example 4

The present embodiment provides an in-situ strengthening and rapid forming method for a thin-walled tube made of a titanium alloy, the method includes the following steps 4.1 to 4.4.

In step 4.1. a TC4 titanium alloy tube blank may be placed in a forming die, and the TC4 titanium alloy tube blank in the forming die can be sealed via sealing punches.

In step 4.2. the TC4 titanium alloy tube blank can be heated to 950° C. (the beta phase transus temperature of the TC4 titanium alloy is 990° C.), the heating rate for the TC4 titanium alloy tube blank may be 100° C./s, the heating time for the TC4 titanium alloy tube blank may be 9.5 s, and the forming die can be maintained at a room temperature.

In step 4.3. when the temperature of the TC4 titanium alloy tube blank reaches 950° C., the heating of the TC4 titanium alloy tube blank can be stopped, and the high-pressure gas may be immediately introduced into the TC4 titanium alloy tube blank via the sealing punches, such that the pressure in the forming die reaches 35 MPa and may be maintained for 3 s. So, the TC4 titanium alloy tube blank bulges and may be closely attached to the cavity of the forming die. The pressure rate for the TC4 titanium alloy tube blank may be 20 MPa/s, and the pressurization time for the TC4 titanium alloy tube blank may be 1.8 s. When the bulged TC4 titanium alloy tube blank contacts the cavity of the forming die which may be at a room temperature, the temperature of the TC4 titanium alloy tube blank can rapidly decrease, and the rapid cooling in the forming die can be completed, so as to obtain a formed tube.

In step 4.4. the high-pressure gas in the TC4 titanium alloy tube blank may be discharged, the formed tube can be cooled, and the forming die can be opened to obtain a thin-walled tube made of the titanium alloy.

### Example 5

The present embodiment provides an in-situ strengthening and rapid forming method for a thin-walled tube made of a titanium alloy, the method includes the following steps 5.1 to 5.4.

In step 5.1. a Ti60 titanium alloy tube blank may be placed in a forming die, and the Ti60 titanium alloy tube blank in the forming die can be sealed via sealing punches.

In step 5.2. the Ti60 titanium alloy tube blank can be heated to 1050° C. (the beta phase transus temperature of the Ti60 is 1040° C.), the heating rate for the Ti60 titanium alloy tube blank may be 100 Celsius ° C./s, the heating time for the Ti60 titanium alloy tube blank may be 10.5 s, and the forming die can be maintained at a room temperature.

In step 5.3. when the temperature of the Ti60 titanium alloy tube blank reaches 1050° C., the heating of the Ti60 titanium alloy tube blank can be stopped, and the high-pressure gas can be immediately introduced into the Ti60 titanium alloy tube blank via the sealing punches, such that the pressure in the forming die reaches 12 MPa and may be maintained for 5 s. So, the Ti60 titanium alloy tube blank bulges and can be closely attached to the cavity of the forming die. The pressure rate for the Ti60 titanium alloy tube blank may be 20 MPa/s, and the pressurization time for the Ti60 titanium alloy tube blank may be 0.6 s. When the bulged Ti60 titanium alloy tube blank contacts the cavity of the forming die which may be at a room temperature, the temperature of the Ti60 titanium alloy tube blank can rapidly decrease, and the rapid cooling in the forming die can be completed, so as to obtain a formed tube.

In step 5.4. the high-pressure gas in the Ti60 titanium alloy tube blank can be discharged, the formed tube may be cooled, and the forming die can be opened to obtain a thin-walled tube made of the titanium alloy.

### Comparative Example 1

The present embodiment provides an in-situ strengthening and rapid forming method for a thin-walled tube made of a titanium alloy, the method includes the following steps 6.1 to 6.4.

In step 6.1. a TC4 titanium alloy tube blank may be placed in a forming die, and the TC4 titanium alloy tube blank in the forming die can be sealed via sealing punches.

In step 6.2. the TC4 titanium alloy tube blank can be heated to 1000° C. (the beta phase transus temperature of the TC4 titanium alloy is 990° C.), the heating rate for the TC4 titanium alloy tube blank may be 2° C./s, the heating time for the TC4 titanium alloy tube blank may be 500 s, and the forming die can be maintained at a room temperature.

In step 6.3. when the temperature of the TC4 titanium alloy tube blank made of the titanium alloy reaches 1000° C., the heating of the TC4 titanium alloy tube blank can be stopped, and the high-pressure gas can be immediately introduced into the TC4 titanium alloy tube blank via the sealing punches, such that the pressure in the forming die reaches 12 MPa and may be maintained for 5 s. So, the TC4 titanium alloy tube blank bulges and can be closely attached to the cavity of the forming die. The pressure rate for the TC4 titanium alloy tube blank may be 15 MPa/s, and the pressurization time for the TC4 titanium alloy tube blank may be 0.8 s. When the bulged TC4 titanium alloy tube blank contacts the cavity of the forming die which may be at a room temperature, the temperature of the TC4 titanium alloy tube blank can rapidly decrease, and the rapid cooling in the forming die can be completed, so as to obtain a formed tube.

In step 6.4. the high-pressure gas in the TC4 titanium alloy tube blank can be discharged, the formed tube may be cooled, and the forming die can be opened to obtain a thin-walled tube made of the titanium alloy.

### Comparative Example 2

The present embodiment provides an in-situ strengthening and rapid forming method for a thin-walled tube made of a titanium alloy, the method includes the following steps 7.1 to 7.4.

In step 7.1. a TC4 titanium alloy tube blank may be placed in a forming die, and the TC4 titanium alloy tube blank in the forming die can be sealed via sealing punches.

In step 7.2. the TC4 titanium alloy tube blank can be heated to 1000° C. (the beta phase transus temperature of the TC4 titanium alloy is 990° C.), the heating rate for the TC4 titanium alloy tube blank may be 15° C./s, the heating time for the TC4 titanium alloy tube blank may be 67 s, and the forming die can be maintained at a room temperature.

In step 7.3. when the temperature of the TC4 titanium alloy tube blank made of the titanium alloy reaches 1000° C., the heating of the TC4 titanium alloy tube blank can be stopped, and the high-pressure gas can be immediately introduced into the TC4 titanium alloy tube blank via the sealing punches, such that the pressure in the forming die reaches 12 MPa and may be maintained for 5 s. So, the TC4 titanium alloy tube blank bulges and can be closely attached to the cavity of the forming die. The pressure rate for the TC4 titanium alloy tube blank may be 15 MPa/s, and the pressurization time for the TC4 titanium alloy tube blank may be 0.8 s. When the bulged TC4 titanium alloy tube blank contacts the cavity of the forming die which can occur at a room temperature, the temperature of the TC4 titanium alloy tube blank can rapidly decrease, and the rapid cooling in the forming die can be completed, so as to obtain a formed tube.

In step 7.4. the high-pressure gas in the TC4 titanium alloy tube blank can be discharged, the formed tube may be cooled, and the forming die can be opened to obtain a thin-walled tube made of the titanium alloy.

### Comparative Example 3

The present embodiment provides an in-situ strengthening and rapid forming method for a thin-walled tube made of a titanium alloy, the method includes the following steps 8.1 to 8.4.

In step 8.1. a TC4 titanium alloy tube blank may be placed in a forming die, and the TC4 titanium alloy tube blank in the forming die can be sealed via sealing punches.

In step 8.2. the TC4 titanium alloy tube blank can be heated to 1000° C. (the beta phase transus temperature of the TC4 titanium alloy is 990° C.), the heating rate for the TC4 titanium alloy tube blank may be 100° C./s, the heating time for the TC4 titanium alloy tube blank is 10 s, and the forming die is maintained at a room temperature, the TC4 titanium alloy tube blank is heated to 1000° C. and kept for 120 s.

In step 8.3. When the temperature of the TC4 titanium alloy tube blank reaches 1000° C., the heating of the TC4 titanium alloy tube blank can be stopped, and the high-pressure gas can be immediately introduced into the TC4 titanium alloy tube blank via the sealing punches, such that the pressure in the forming die reaches 12 MPa and may be maintained for 5 s. So, the TC4 titanium alloy tube blank bulges and can be closely attached to the cavity of the forming die. The pressure rate for the TC4 titanium alloy tube blank may be 15 MPa/s, and the pressurization time for the TC4 titanium alloy tube blank may be 0.8 s. When the bulged TC4 titanium alloy tube blank contacts the cavity of the forming die which can occur at a room temperature, the temperature of the TC4 titanium alloy tube blank can rapidly decrease, and the rapid cooling in the forming die can be completed, so as to obtain a formed tube.

In step 8.4. the high-pressure gas in the TC4 titanium alloy tube blank can be discharged, the formed tube may be cooled, and the forming die can be opened to obtain a thin-walled tube made of the titanium alloy.

### Experimental Example 1

The strengths and the elongation of the original materials of the TC4 titanium alloy and the thin-walled tubes made of the titanium alloy which may be manufactured by using the method of the Examples 1-2 and the Comparative Examples 1-3 above, and the microstructure morphologies of the thin-walled tubes made of the titanium alloy which may be manufactured by using the methods of the Example 2, the Comparative Example 1 and the Comparative Example 3 can be measured to obtain measurement results.

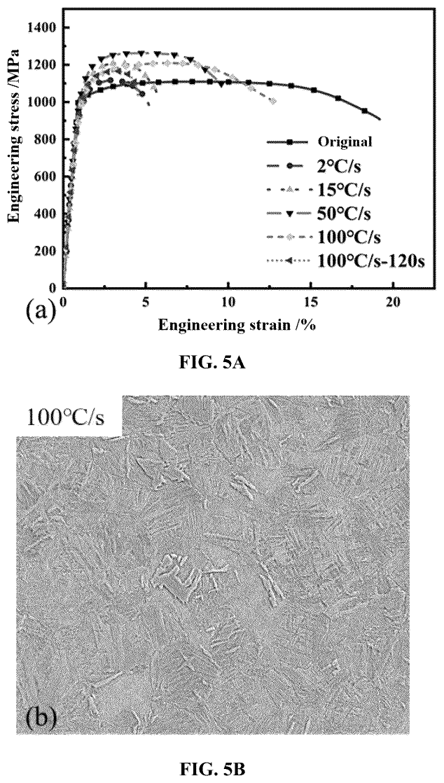

The measurement results are as shown in FIG. 5A to FIG. 5D, in which FIG. 5A is a comparison diagram of different treatment strengths and elongation of the thin-walled tubes made of the titanium alloy, and FIG. 5B, FIG. 5C and FIG. 5D are exemplary microstructure morphologies of thin-walled tubes made of the titanium alloy prepared by the methods of the Example 2 above, the Comparative Example 1 above and the Comparative Example 3 above, respectively. In FIG. 5A, “Original” denotes the performance of the original material of the TC4 titanium alloy; “2° C./s” denotes that a engineering stress-strain curve of the thin-walled tube made of the titanium alloy prepared by the method of Comparative Example 1, where the heating rate is 2° C./s; “15° C./s” denotes that the thin-walled tube made of the titanium alloy may be manufactured by the method of the Comparative Example 2; “50° C./s” denotes that the thin-walled tube made of the titanium alloy is manufactured by the method of Example 1; “100° C./s” denotes that the thin-walled tube made of the titanium alloy is manufactured by the method of Example 2; and “100° C./s-120 s” denotes that the thin-walled tube made of the titanium alloy is manufactured by the method of Comparative Example 3. It can be seen from the FIG. 5A that when the heating time for the tube blanks can be controlled within 1 min, and after heating the tube blanks, the strengths of the materials of the thin-walled tubes made of the titanium alloy without the heat preservation may be significantly improved by 10-20% with respect to the original material of the TC4 titanium alloy and the thin-walled tubes of the Comparative Examples 1-3, and the elongation of the thin-walled tubes made of the titanium alloy prepared in Example 1 and Example 2 are not less than 7%. It can be seen from FIG. 5B, FIG. 5C and FIG. 5D that the heating rate is 100° C./s, the heating time for the tube blanks is controlled within 1 min, and the heated thin-walled titanium alloy tubes without heat preservation contain more fine martensites, which can improve the performance of the thin-walled tubes. However, although martensites may also be generated in the thin-walled tubes made of the titanium alloy in Comparative Examples 1 and 3, the martensites are relatively large and may result in a decrease in the performance of the resulting tubes.

It can be seen from FIG. 5A to FIG. 5D that, when the heating rates for the thin-walled tubes made of the titanium alloy are high and the total heating time for the thin-walled tubes made of the titanium alloy is within 1 min, the strengths of the materials of the obtained thin-walled tubes made of the titanium alloy can be significantly improved, and the elongation achieved may be high. So, it indicates that the thin-walled tubes may possess a higher strength and plasticity, and have excellent performance. However, if the heating rates for the thin-walled tubes are relatively low or the heat preservation for the thin-walled tubes is performed after the heating, there is may be a result that the total heating time for the thin-walled tubes can be more than 1 min and the strengthening effect and the plasticity of the obtained thin-walled tubes made of the titanium alloy may be reduced. This may be primarily be caused by the extended heating time for the thin-walled tubes which may result in large growth of beta phases, which can affect the performance of the thin-walled tubes made of the titanium alloy.

### Experimental Example 2

The strengths and the elongation at 600° C. of the original Ti60 titanium alloy and the thin-walled tube made of the Ti60 titanium alloy prepared by the method of Example 5 are measured to obtain measurement results and compared with each other.

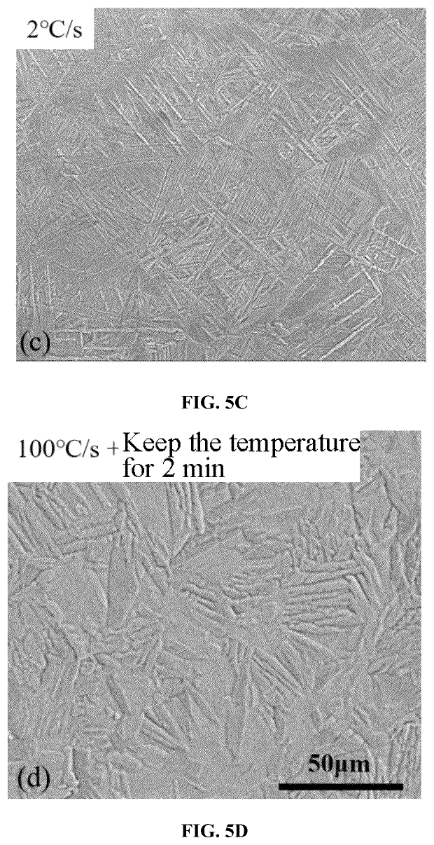

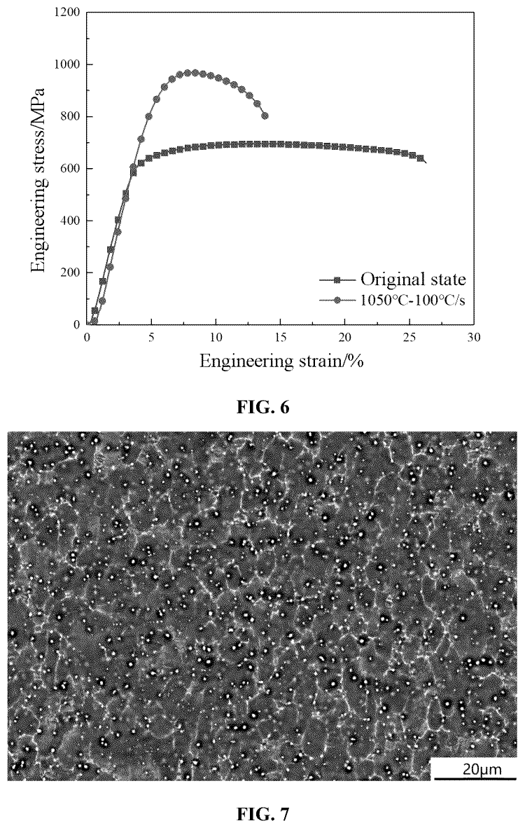

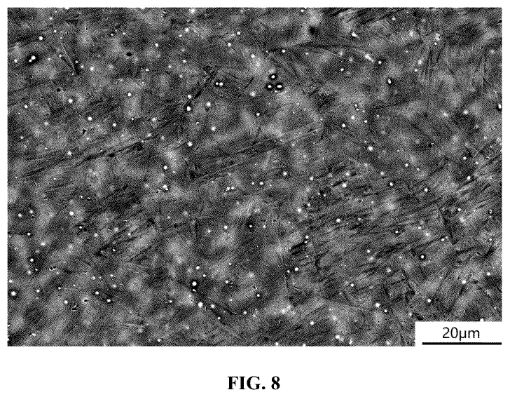

The measurement results are shown in FIGS. 6-8, where FIG. 6 is a comparison diagram of engineering stress-strain curve. In the FIG. 6, “Original state” donates the performance of the original Ti60 titanium alloy, and “1050-100° C./s” donates the thin-walled tube made of the Ti60 titanium alloy after being heated to 1050° C. at a heating rate of 100° C. is according to Example 5. FIG. 7 is a microstructure diagram of the original Ti60 titanium alloy. FIG. 8 is a microstructure schematic diagram of the thin-walled tube of a Ti60 titanium alloy obtained after the processing of the method of Example 5.

It can be seen from FIG. 6 that the tensile strength of the original Ti60 titanium alloy at 600° C. is 696.11 MPa, while the tensile strength of the thin-walled tube made of the Ti60 titanium alloy at 600° C. obtained by the method of Example 5 is 968.68° C., which has an improvement of 39.16% compared with the original Ti60 titanium alloy. The elongation of the original Ti60 titanium alloy at 600° C. is 25.92%, while the elongation of the thin-walled tube made of the titanium alloy obtained by the method of Example 5 at 600° C. is 13.05%.

In addition, it can be seen from FIGS. 7 and 8 that a large amount of fine martensites exists in the thin-walled tube made of the Ti60 titanium alloy obtained by the method of Example 5, thereby significantly improving the high-temperature performance of the material of the thin-walled tube.

Although the present disclosure is disclosed above, the scope of protection of the present disclosure is not limited thereto. Those skilled in the art can make various changes and modifications without departing from the spirit and scope of the present disclosure, and these changes and modifications shall fall in the scope of protection of the present disclosure.

What is claimed is:

1. An in-situ strengthening and rapid forming method for a titanium alloy tubular component, the method comprising:
at a step S1, placing a titanium alloy tube blank in a forming die, said forming die is at a room temperature, and sealing said titanium alloy tube blank in said forming die by sealing punches after said forming die is closed;
at a step S2, heating said titanium alloy tube blank rapidly, and controlling a heating time for said titanium alloy tube blank to be within 1 min;
at a step S3, stopping heating said titanium alloy tube blank when a temperature of said titanium alloy tube blank reaches a predetermined temperature, and immediately introducing a compressed gas into said titanium alloy tube blank, rapidly bulging said titanium alloy tube blank and closely attaching said titanium alloy tube blank after being bulged to an inner wall of a cavity of said forming die; and after a pressure in said titanium alloy tube blank reaches a predetermined pressure, maintaining said predetermined pressure in said titanium alloy tube blank and cooling said titanium alloy tube blank, so as to obtain a formed tube, wherein a pressurization time for said pressure in said titanium alloy tube blank to said predetermined pressure is controlled within 2 s, and a dwell time for maintaining said predetermined pressure in said titanium alloy tube blank is 3-10 s; and
at a step S4, discharging said compressed gas in said formed tube after said formed tube is cooled, so as to obtain the titanium alloy tubular component.

2. The method of claim 1, wherein, the step S3 further comprises:
introducing said compressed gas into said titanium alloy tube blank via said sealing punches, such that said titanium alloy tube blank bulges, and is closely attached to said inner wall of said cavity of the forming die, wherein said titanium alloy tube blank is in a high-temperature state, and said forming die is in a room temperature state; cooling said titanium alloy tube blank after being bulged rapidly by said forming die to obtain said formed tube, thereby forming a plurality of fine martensites inside said formed tube.

3. The method of claim 1, wherein in the step S3, said predetermined temperature is within a range of 50° C. around a beta phase transus temperature of said titanium alloy tube blank.

4. The method of claim 3, wherein the step S2 further comprises: controlling a heating rate for said titanium alloy tube blank at 10-200° C./s; and when said predetermined temperature is greater than or equal to the beta phase transus temperature of said titanium alloy tube blank, controlling said heating rate at 50-200° C./s.

5. The method of claim 1, wherein the step S3 further comprises: introducing said compressed gas into said titanium alloy tube blank, such that said pressure in said titanium alloy tube blank reaches 5-35 MPa.

6. The method of claim 5, further comprising: when said predetermined temperature is less than a beta phase transus temperature of said titanium alloy tube blank, enabling said pressure in the titanium alloy tube blank to reach 10-35 MPa; when said predetermined temperature is greater than or equal to the beta phase transus temperature of said titanium alloy tube blank, enabling said pressure in the titanium alloy tube blank to reach 5-15 MPa.

7. The method of claim 5, further comprising: controlling a pressurization rate for said pressure in said titanium alloy tube blank to said predetermined pressure to be above 10 MPa/s.

8. The method of claim 1, wherein the step S2 further comprises: heating said titanium alloy tube blank in an electric current heating manner.

9. The method of claim 1, wherein said titanium alloy tube blank comprises an at least one titanium alloy from a group of titanium alloys, said group of titanium alloys consisting of TA18, TA15, TC2, TC4, TC31, Ti55, Ti60 and Ti65.
